(19) United States
(12) Patent Application Publication
(10) Pub. No.: US 2004/0015835 A1
(43) Pub. Date: Jan. 22, 2004

(54) Dynamic distribution and integration of computer code objects

(76) Inventors: Sasank Kotnur, Bangalore (IN); Sreekrishna Kotnur, Bangalore (IN)

Correspondence Address: Welsh & Katz, Ltd., 22nd Floor, 120 South Riverside Plaza, Chicago, IL, 60606, US

(21) Appl. No.: 10/056,708

(22) Filed: Jan. 24, 2002

(51) Int. Cl. G06F 9/44

(52) U.S. Cl. 717/106; 717/116; 717/118

(57) ABSTRACT

A system having an Object Distributor and Integrator creates distributed software objects from non-distributed objects developed in different programming languages without requiring a human to explicitly program the objects with code specific to making the objects distributed, wherein the objects are of the type (but not restricted to) .dll, .class, or .obj. The Object Distributor and Integrator also provides integration of the objects with distribution specific code, with the distributed environment, dynamically and at runtime, without having to code reprogram the objects with code specific to the integration. The system may employ a method for dynamically distributing and integrating one or more non-distributed objects, including publisher objects and subscriber objects in a distributed environment. Generally, the method includes the steps of selecting at least one method of the non-distributed object, generating distribution code to enable the distribution of the object, and integrating the object in the distributed environment.

### FIELD OF INVENTION

The present invention relates generally to the computer programming methods of creating distributed objects or programs and integration methods, and in particular to Object Oriented Programming methods and to the method of integrating objects and programs of different types (i.e., native and non-native) (hereinafter “objects”) with Object Request Brokers, Middleware, Servers or any application implementing this invention.

### BACKGROUND OF THE INVENTION

Many mission-critical computer software applications today make extensive use of distributed computing to share information over large, heterogeneous computer networks. Distributed and localized computer programming objects require a mediator to establish communication between one another and to encapsulate information by preventing direct access to each other's objects. One of the most widely used mediating mechanism for distributed computing is an Object Request Broker (“ORB”). In this known mediating mechanisms, Objects establish communication with the ORB to transact with other objects. ORBs serve as the medium of communication between localized, distributed objects and programs, by exposing Application Programming Interfaces (“APIs”), through which objects can integrate with the Object Request Broker. Other known mediating mechanisms include MOM, RPC and Tpmonitors.

“Middleware” in a strict sense refers generically to the transport software that is used to move information, from one program to one or more other programs, shielding the developer from dependencies on communication protocols, operating systems and hardware platforms. As the distributed model of enterprise computing has become more common, the term “middleware” has acquired numerous additional meanings that allow the term middleware to refer to just about any piece of software that sits between systems. In more general terms, middleware provides the ‘plumbing’ necessary for applications to exchange data, regardless of the environment in which they are running.

Over the years several new protocols have been developed in the hopes of improving efficiency and reducing complexity. However, it is precisely this growth of several communication protocols that has led to the contrary. New and numerous communication protocols require companies incur time and expense related to employees learning and adapting to newer languages and programming paradigms.

Drawbacks of having numerous existing middleware communications protocols include complexity, lack of desired functionality, lack of clear benefits, and expense. For example, different types of middleware have been developed to serve different purposes and for specific computer programming languages. No one type of previously known middleware may be right for every situation. On the contrary, oftentimes a situation requires different kinds of middleware within the a single application. For example, an ERP application might include synchronous transaction processing middleware, object brokering middleware, and database access middleware.

One approach to overcome the drawbacks of known middleware protocols is to form standards. However, this “standards” solutions suffers from the same drawback of simply having too many standards. It is believed that there are as many standards as there are programming languages and paradigms such as CORBA, and DCE. To implement a standards-based solution, therefore the user is forced to not only decide on the language, architecture, and hardware of a system, but also on standard to adopt for the system.

As a result, almost all of the ORBs available today present different APIs and standards, which the developer or the Integrator would have to adhere to. Further, the APIs would have to be programmed in the way specified by the ORB vendor. To program these APIs, one needs to spend valuable time and money to initially learn and then to implement the necessary programs to make the object distributed and to integrate the object on to the ORB. This entire process is repeated whenever any changes or enhancements are made to the ORB. Moreover, while the changes or enhancements are made to a object/ORB, the entire system would have to be brought down, leading to disruption of services temporarily.

Another known attempt to reduce complexity in using middleware involved automation of the generation of code specific to distributing. See, for example, U.S. Pat. No. 6,157,960. The method of the '960 patent involves generating double prime proxies. The first proxy would reside on one machine and the second proxy would reside on another machine where the calling class would also reside. This results in the calling class (subscriber) having to call on the second proxy and then the second proxy through the interface generated would call upon the first proxy, which would in turn call upon the actual computing class. The return values are passed across the same way. The '960 method also distributes different sets of distribution files, the single prime proxies at one end and an interface and the double prime proxy at the Subscriber end. This involves two sets of files being copied or transferred among different machines. The '960 patent uses the known method of using standard Java programming practices to detect declared methods in a Java bytecode or class file, but distributes all the methods in the selected object.

What is needed is a reduction in the complexity of using middleware communication protocols. In this regard, what is needed is a single universal middleware, which can handle every type of connection and integration, which can integrate different objects and programs without having to manually write code, and which can automatically distribute a non-distributed program.

Also, what is needed is a method of distributing and integrating different objects or programs developed in different languages under one infrastructure, without requiring the integrator or the programmer to code the objects or programs with distribution and integration specific code. In this regard, what is needed is a mechanism by which one can not only specify which object or object to publish and or subscribe but also specify without coding which method in an object or program to publish or subscribe, without generating multiple sets of distribution files.

### SUMMARY OF THE INVENTION

An Object Distributor and Integrator (“ODI”) is presented to create distributed software objects from non-distributed objects developed in different programming languages without requiring a human to explicitly program the objects with code specific to making the objects distributed, wherein the objects are of the type (but not restricted to) .dll, .class, or .obj.

This Object Distributor and Integrator also provides integration the objects with distribution specific code, with the distributed environment, dynamically and at runtime, without having to code reprogram the objects with code specific to the integration. The Object Distributor and Integrator dynamically and at runtime without having to explicitly code, publishes and/or subscribes specific methods of an object. The Object Distributor and Integrator facilitates communication between objects or programs developed in Java and non-Java programming languages, wherein the said objects or programs are of the type (but not restricted to) .class, .dll, or .obj.

A method for dynamically distributing and integrating one or more non-distributed objects, including publisher objects and subscriber objects, whether written in Java language or another native language, in a distributed environment is also provided. Generally, the method includes the steps of selecting at least one method of the non-distributed object, generating distribution code to enable the distribution of the object, and integrating the object in the distributed environment. Additional steps may include extracting at least one method for each object, storing methods selected for publishing and subscribing, for each non-Java object, generating translation code to translate the non Java object into a Java object, generating distribution code for each publisher object, generating subscription specific code for each subscribing object, wherein the subscription specific code contains subscribed methods of at least one publisher object, generating integration specific code to integrate each object with middleware, and generating archive files for distributing a final output after compilation.

Where the object is a Java program having more than one public method, the step of extracting at least one method for the object may also include extracting the public methods of the object, allowing for the selection of one or more of the extracted public methods, and publishing the selected extracted public method. Where the object is a subscriber object, the step of extracting a method for the object may include extracting a plurality of public methods of at least one publisher object from a repository of middleware, allowing for the selection of at least one of the extracted public method, and subscribing the subscribing object to the selected extracted public method.

### BRIEF DESCRIPTION OF THE DRAWINGS

FIG. 1 is a flow chart illustrating an example of integration of a publisher object according to the present invention.

FIG. 2 is a flow chart illustrating an example of integration of a subscriber object according to the present invention.

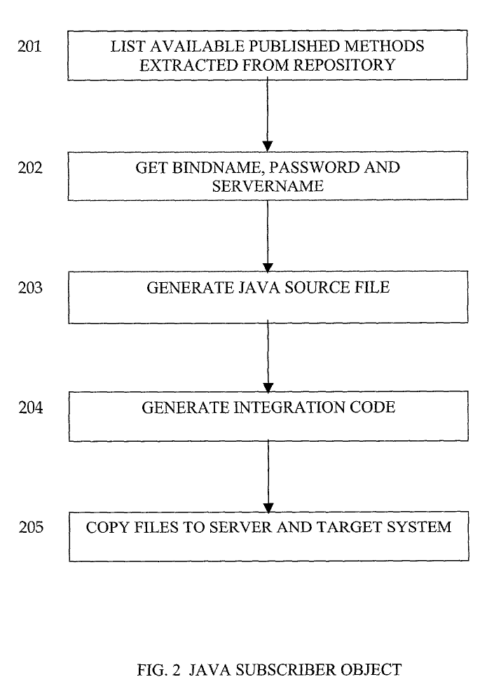

FIG. 3 is a flow chart illustrating an example of distributing and integrating a native object according to the present invention.

FIG. 4 illustrates an example of a Method Level Access mechanism of the present invention.

FIG. 5 illustrates an example of a deployment view for Java publisher and subscriber objects.

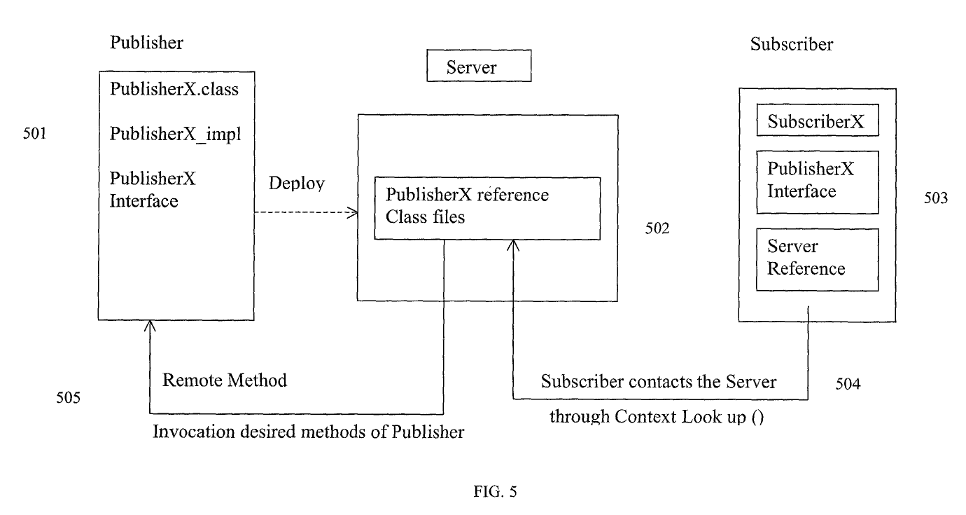

FIG. 6 illustrates an example of a deployment view and object call transmission for native non-Java publishing objects and Java subscriber objects.

FIG. 7 is an example of a network on which both Java and non-Java native objects can appear.

FIG. 8 is a block diagram illustrating functional blocks of one example of the present invention.

### DETAILED DESCRIPTION OF THE INVENTION

The preferred embodiment of the present invention is herein described in more detail with reference to the drawings. The present invention is not restricted to the preferred embodiment. The present invention is applicable to any automated process of making a non-distributed localized objects, programs distributed, and establishing communication between Java and non-Java objects, objects and programs.

The preferred embodiment uses the Java programming language and environment. It may be noted that the implementation of this present invention is not restricted to Java only. This invention may be easily applied to other programming languages by anyone skilled in the art of programming. The example of the preferred embodiment illustrated herein also assumes that a programmer has written a program, object or program to run locally or as standalone, without code to make it distributed. An example of code to make a program distributed is Sun Java remote method invocation code (RMI)

It is common knowledge that the Java compiler generates bytecode files in a well-known format, which contains the instructions to the Java interpreter and a list of public methods in the class. It is possible for one skilled of art to extract the public methods in the bytecode using standard programming techniques.

Generally, the Object Distributor and Integrator enables the distribution and integration of different objects or programs developed in different languages under one infrastructure, without requiring the integrator or the programmer to code the objects or programs with distribution and integration specific code. Users need not bother about these disparate languages and standards, but only need to think of the business logic that suits them. Using the present invention, developers can create distributed objects or programs from non-distributed objects or programs of the type .class, .dll and .obj, and integrate the objects on to the infrastructure without having to program any Application Programming Interfaces (“API”).

The Object Distributor and Integrator eliminates the necessity for the developer or programmer to be aware of the techniques or methods, required to create distributed programs or objects. The developer need only create an ordinary program or a standalone program useful for localized or standalone computing, compile the source, into byte codes in the form of a .class (if in Java), or as a .dll, or .obj (if in non-Java or native languages). The developer then selects the programs or objects to be made distributed.

The present invention is based on a Publish/Subscribe Mechanism and Group principles. In this Publish/Subscribe environment a object can publish certain or all of its methods to be used by others, and the subscriber avails the service, either by subscribing to one or all of the Publisher's published methods. A group is a collection of objects or program with similar attributes. The present invention allows an object or program to be a member of more than one group. Accordingly, the Object Distributor and Integrator does not require double prime proxies to be generated, as previously known, but instead generates a interface that overlaps the computing class and then subsequently an implementation class is generated. The subscriber contacts the server's reference and not the publishing object's reference. Only the server's reference is provided to the subscriber. So all calls made by the subscriber, on any of the publishers that it has subscribed to, are routed only through the server/middleware. Also, there is only one set of files being transferred and that is at the server end, and not at the subscriber end. The subscriber need not have the publishers remote reference files (stubs), the subscriber needs the reference of the server, which is a generic reference given to all subscribers. Accordingly, the amount of code generated each time a publisher is subscribed to by the same subscriber is negligible at the subscriber end because the references of the publishers are not given to the subscriber.

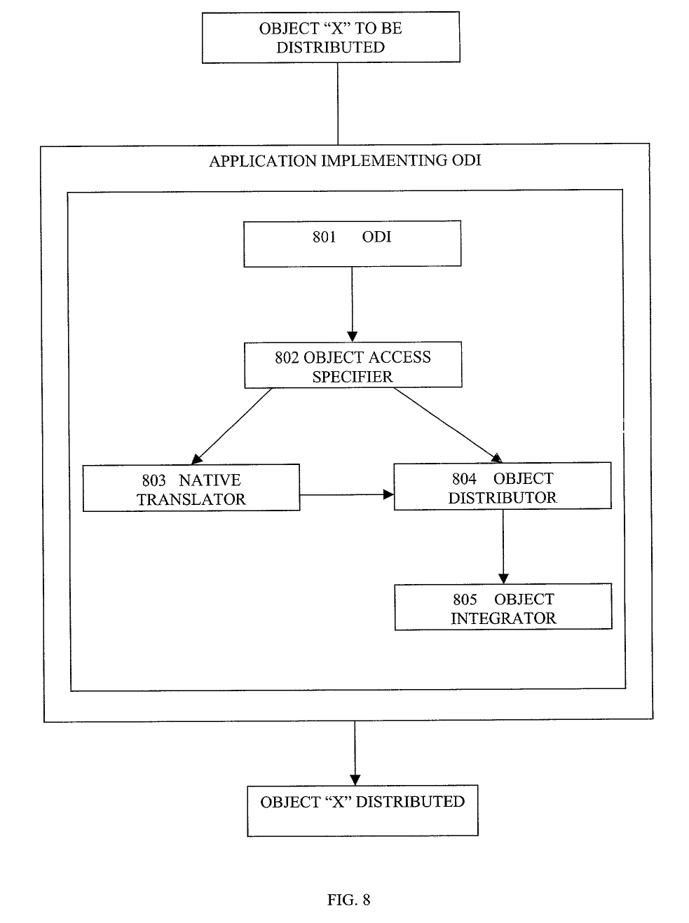

Referring to FIG. 8, an application implementing an Object Distributor and Integrator 801 may have an Object Access Specifier 802, a Native Translator 803, an Object Distributor 804, and an Object Integrator 805. On selection of programs or objects to be made distributed, the Object Access Specifier 802 of the Object Distributor and Integrator extracts the public methods in the byte code (if in Java), using standard Java programming techniques, and displays it in the user interface. The programmer or the integrator may choose or specify all those methods which needs to be published and/or subscribed (i.e, distributed). If the objects or programs are of non-Java type, then the programmer or the integrator has to specify the methods to be published in the user interface accompanying this invention.

On selection the Object Distributor 804 of the ODI of the present invention generates code, which contains distribution specific instructions. The objects and/or programs thus developed are compiled and the resulting byte codes are then distributed, placed in the target destination specified by the programmer, or the integrator, and integrated with the distributed environment, by the Object Integrator 805 of the ODI. The files may be located in a repository, which may be local or may be remote, such as in a network environment.

Using the Object Distributor and Integrator, one is able to dynamically and at runtime able to create distributed programs, and objects from non- distributed objects, and programs, developed in Java or non-Java programming languages, and integrate them dynamically on to the middleware, server, ORB, or other application implementing this invention.

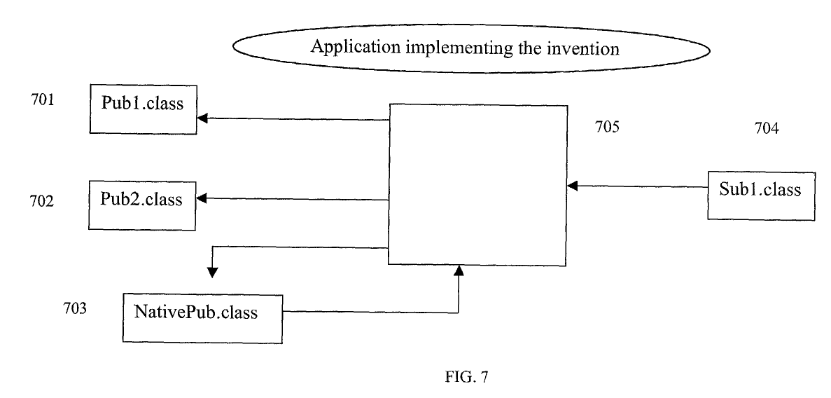

FIG. 7 illustrates a network or application on which both Java and non-Java objects are deployed. An application (e.g., Middleware, Server, ORB, or other application) implementing this invention is also shown. A server 705 has registered or deployed with it Java publishers 701, 702 and non-Java native publishers 703. A subscriber 704 looks up to the server 705 for the published methods of the publishers. The process for publishing and subscribing methods is provided in more detail below.

FIG. 8 is a block diagram for distributing objects. The present invention generates a interface which contains the declarations of the method chosen to be published, and then subsequently generates the proxy of this, which contains the distribution code or to be more specific Remote Method Invocation Code (RMI), which enables the implementing or proxy to be invoked remotely from the server. Once the interface is generated the Object Distributor 804 of this invention generates an implementation file for the generated interface. The Object Integrator 805 also generates integration code required to integrate the object with the server, middleware or any application implementing this invention. This middleware or application specific code required for integration can be changed as needed. The Object Integrator 805 generates a context of the server for the objects. The objects communicate with the server using this mechanism. In the present invention only those methods specified by the user are made distributed.

Advantages of the Object Distributor and Integrator of the present invention include the ability to:

1. Dynamically and at runtime without having to explicitly code, publish and or subscribe specific methods of an object.

2. Create distributed objects or programs from a non-distributed objects or programs developed in the Java or non-Java programming language without the user having to explicitly code or program the objects or programs with code specific to making the objects or programs distributed.

3. Integrate dynamically and at runtime without programming the objects, or programs with distribution code, with code specific to integration, required to integrate with the distributed environment.

4. Establish communication between objects or programs developed in different programming languages, wherein the said objects or programs are of the type (but not restricted to) .class, .dll, or .obj.

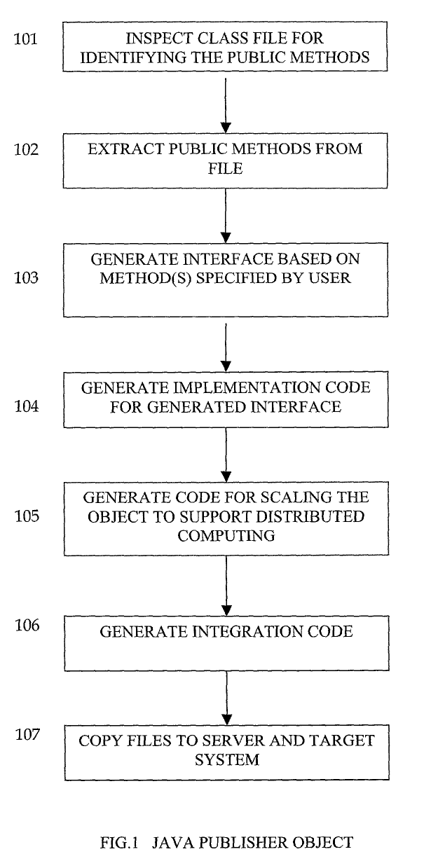

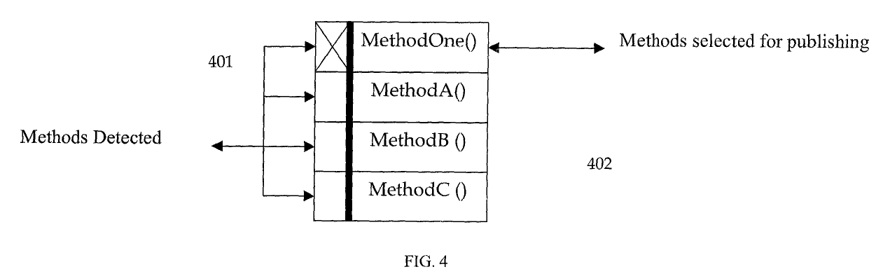

More specifically, referring to FIGS. 1 and 4, one example of the present invention involves distribution and integration of selected class files with reference to the object being the publisher and being of type class. The Object Access Specifier 802 inspects the class file and extracts the list of the methods 101 in the Java bytecode using standard Java API calls. The step of extracting public methods from the list of methods 102 may be performed by displaying the list in a user interface. The user may then select one or more methods to be published.

In one example, the Publishing object or program has public methods MethodA( ), MethodB( ), MethodC( ) and MethodOne( ). The Object Distributor and Integrator extracts all of the public methods from the bytecode file and displays them in the user interface 401. The programmer or the integrator selects which of the extracted methods to publish by checking a check box 402 in the user interface. Upon selection of the methods, an interface which contains the specified published methods is generated 103.

Continuing with the example, the publishing Java class is PublisherX.class and has public methods MethodA( ), MethodB( ), MethodC( ), and MethodOne( ). The programmer or the integrator selects for publication the public method Public int MethodOne( ). The Object Distributor and Integrator generates interface PublisherXInterface containing code specifying the selected method. One example of suitable code is given in Table A.

TABLE A

public interface PublisherXInterface extends
Remote
{
public int MethodOne(java.lang.String $param0,
java.lang.String $param1, java.lang.String
$param2) throws java.rmi.RemoteException ;

}

The Object Distributor generates the implementation code file 104 for the interface generated based on methods specified by the user 103. The implementation file/class is a wrapper class for the interface generated since interfaces are only a means of access to another class' functionality and are not computing classes by themselves. The ODI may generate code for scaling the object to support distributed computing 105 and may generate integration code 106. The implementation file may therefore contain code for the distribution of the object code with which the object of the program will register with the RMI registry, code to identify the group to which the object belongs, wrapper code for the published methods of the object, and code for integrating the object of program with the middleware or server of any application. Table B gives one example of code for the distribution of the object. Table C gives one example of code for registering an object with the RMI registry. Table D gives one example of code to identify the group to which the object belongs. Table E gives one example of wrapper code for the published methods of the object. Table F gives one example of code for integrating the object of program with the middleware or server.

TABLE B
/**This is the wrapper class PublisherX_Impl generated by the ODI,
implementing the PublisherXInterface and PublisherX's published
methods. By importing the RMI related packages and by extending the
class UnicastRemoteObject the class PublisherX_Impl is made distributed
**/
import java.rmi.*;
import java.rmi.server.*;
import java.rmi.registry.*;
public class PublisherX_Impl extends
UnicastRemoteObject implements
PublisherXInterface {
//Reference of publishing object.
PublisherX instance;
// Instantiating the Publishing object's class
instance = new PublisherX( );

TABLE C

/**Deriving the RMI registry at the
specified port number and subsequently
binding to the registry. **/
Registry reg = LocateRegistry.createRegistry(portNo);

reg.rebind(bindName,this);

TABLE D

/**The underlying code is the
authentication code to authenticate to
which group the object belongs to. Every
time the object is initialized it needs to
authenticate its group name with the
server. This is to enable the publish /
subscribe mechanism. **/
String groupName=“Server”;

TABLE E

// Constructor for the class
public PublisherX_Impl( ) throws
java.lang.Exception
//Published methods of the publisher
public int MethodOne(java.lang.String
$param0,java.lang.String $param1,java.lang.String
$param2)
/**The wrapper class directs the method
calls to the publisher object's instance**/

return

instance.MethodOne($param0,$param1,$param2);

TABLE F
/** The underlying code derives the
reference of the server or middleware at
run time In this example the code derives
the reference of a Middleware known as
the SEServer. **/
com.obj.se.server.ObjectServerInterface server;
//Reference of server port number.
int portNo=1600;
/**Reference of object's biudname. The
middleware implementing this invention
requires that the objects authenticate
themselves by a unique bind name,
through which they would be bound to the
server. **/
String bindName=“PubX”;
// Reference of the Server
String serverName=“Mach1”;
// Code that connects to the Main Server
after deriving its remote reference.
try{
server=(com.obj.se.server.ObjectServerInterface)Naming.lookup(“rmi://“+serverName+”
:5677/ObjectServer”);
}catch(Exception e){

try{

System.out.println(“exception in contacting main server”+e);
/**Method call to register the publisher
with the server. This code is middleware
specific. **/

server.acceptObject(java.net.InetAddress.getLocalHost( ).getHostAddress( ),port
No+“”,bindName,groupName);

/**Instantiating the wrapper class**/
public static void main(String [ ]args) throws java.lang.Exception

{
new PublisherX_Impl( );
System.out.println(“Object Registered . . . ”);

}

The Object Distributor and Integrator then compiles the generated code and subsequently copies the output files 107 to a network 500. The network 500 may include a destination for publisher files 501, a server for reference files 502, and a destination for subscriber files 503. Subscribers may contact the server 502 through context lookup 504. The Object Distributor and Integrator also places the reference files of the publishing object with the server (in this case PublisherX reference files) 502, thus making the Publishing object or program distributed and integrating it with the server, middleware or any application implementing this invention. In an alternate embodiment, when the Subscriber calls for the subscribed method of the publisher, the server, middleware, or the application implementing this invention, through Remote Method Invocation (RMI) and the publishers reference invokes the published methods 505.

Generally, for an object or a program to be a Subscriber, it should be developed in the Java programming language. Objects or programs developed in native languages or of type .dll and .obj generally can be Publishers only and not Subscribers. To distribute the selected class files the Object Distributor and Integrator does the following with reference to the object being a subscriber and of type class:

1. The Object Access Specifier of the Object Distributor and Integrator extracts from the repository the list of the published objects and their published methods and displays the information in the user interface 201.

2. The Object Distributor of the Object Distributor and Integrator obtains a bind name, password, and server name from the user. Based on the integrator's selection of the publisher and method calls to subscribe to, and the user entered bind name, server name, and the password, the Object Distributor then generates a Java source file 203.

3. The Object Integrator of the Object Distributor and Integrator then generates integration code 204.

4. The Object Distributor and Integrator then copies the files or classes relating to the interfaces of the publishers subscribed to by the subscribing object and the server's remote reference, to the destination specified by the user 205, which may be subscriber file destination 503.

5. The programmer or the integrator adds the requisite business logic in the generated source files and compile them. The business logic varies with each application and, consequently, no example need be provided.

The Java source file may include code for the subscribing object or program to establish communication and for integration with the server, middleware or any other application and a list of methods of the publisher to which the subscribing object has subscribed.

Table G gives an example of code for the subscribing object or program to establish communication and for integration with the server or middleware. Table H gives an example of code for list of methods of the publisher to which the subscribing object has subscribed.

TABLE G
import com.obj.se.server.*;
public class SubscriberX{
SubscriberX( ){

try{

/** Authenticate the subscriber and getting
the context reference. This code also
contains the ServeName, the Bind name of
the Subscriber and the Password that the
subscriber would use to connect with the
server. These are generated by ODI and
are derived from the User interface
accompanying this invention. **/
com.obj.se.server.Context ctx = new com.obj.se.server.Context(“Mach1”,“SubX”,SubPass”);
/** Code to derive the Reference of the Publisher
Proxy Held within the Server.**/
compInstance1=(PublisherXInterface)ctx.lookup(“PubX”);
}
catch(Exception ex){

System.out.println(“Exception caught”+ex); }}}

/** Here the “PubX” is the Publisher's
Bind Name, through which the Server can
authenticate and identify the subscriber.**/

TABLE H

//Method Invocation Code generated by ODI.

compInstance1. MethodOne(String 0, String 1,

String 2);
[Developer-added business logic may be inserted here].
//The main method required to instantiate the class
public static void main(String args){
new SubscriberX( );}

The subscriber calls upon the server for the subscribed method of the publishing objects through ctx.lookup, which is the servers context.

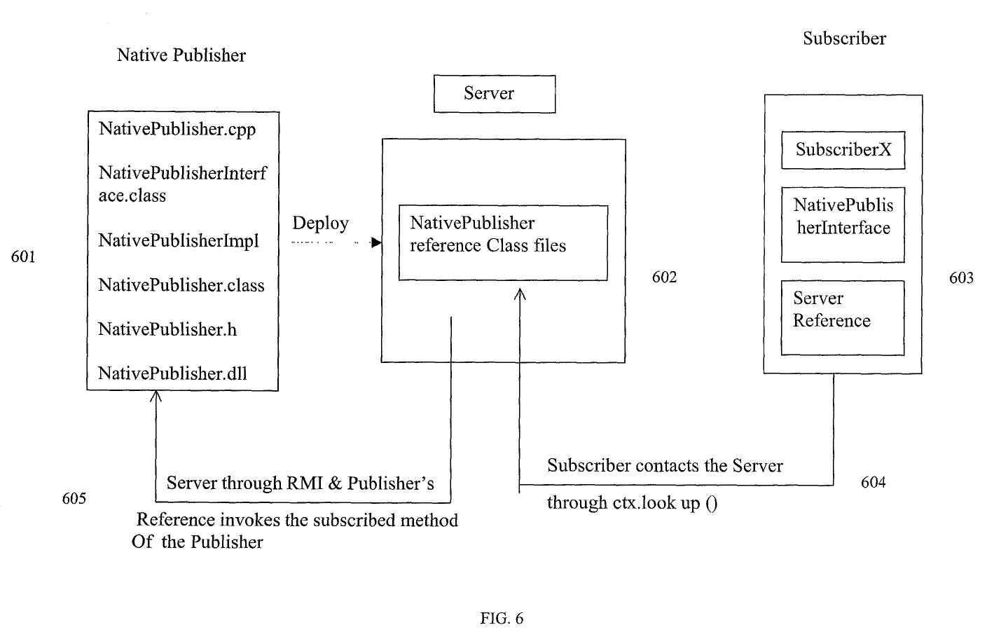

An object or a program developed in a non-Java programming language and of the type .dll or .obj can only publish its methods, and cannot subscribe to methods of other publishers. FIG. 6 is an example of a network 600 having native/non-Java publisher objects and Java subscriber objects. The network 600 may include a destination for native publisher files 621, a server for Native Publisher reference class files 602, and a destination for subscriber files 603. Subscriber objects may contact the server 602 through .ctx lookup 604. The server may access the Native Publisher files through RMI 605.

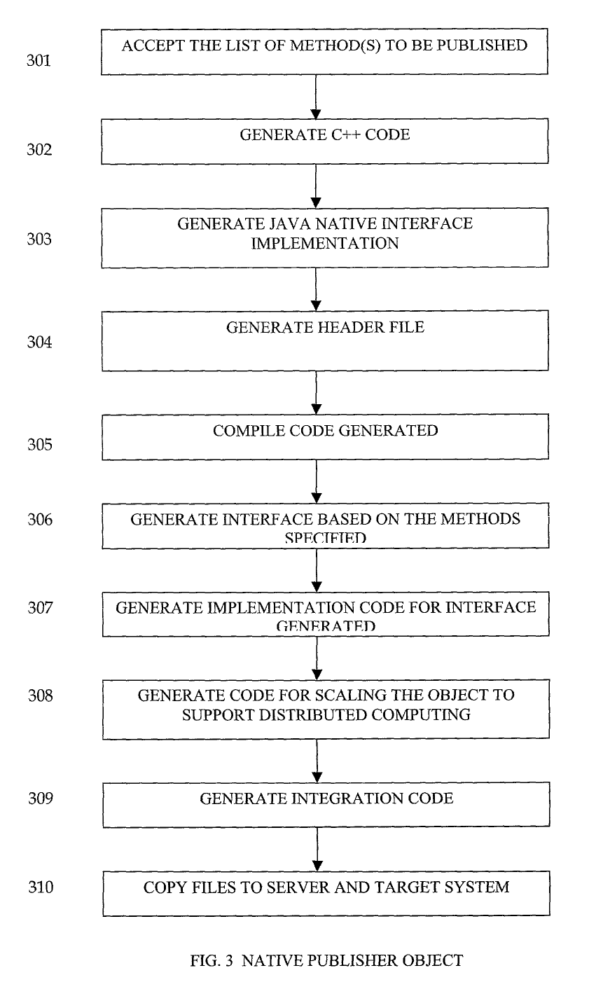

Referring to FIG. 3, to distribute the selected class files the Object Distributor and Integrator does the following with reference to the object being a Publisher, and of type .dll and or .obj, and developed in a non-Java programming language:

1. The ODI accepts a method or list of methods to be published 301. In one example, a user interface through which the user can select the native object and enter the list of methods and their signature to be published is used. Based on the user's specified methods, the Object Access Specifier of the ODI stores the methods and its details for publishing. The Object Distributor and Integrator collects the methods from the Object Access Specifier and passes the same to the Native Translator.

2. The Native Translator 803 of the present invention automatically generates a C++ implementation program file 302 that calls on the published methods of the native object.

In one example, the Native Translator generates the underlying code. The input file to the Object ODI is a DLL NativePublisher.dll in this example. The Native Translator first generates the CPP implementation file for the NativePublisher Object. The CPP file contains the code to call upon the DLL file and instantiate it. In this example, the method public int add( ) is the specified or chosen method to be published. Table I includes an example of code for the CPP file.

TABLE I

// Generated CPP File: NativePublisher.cpp
/** The task of this C++ program generated
by the ODI is to load the DLL or the OBJ
file. Inheriting the libraries / header files
required.**/
/** The header file of the Java Native
interface, the Mechanism provided by Sun
Microsystems' Java Programming
language.**/
#Include <jni.h>
// The header file of the NativePublisher,
this header file is generated by the JAVAH
compilation of the NativePublisher.Java
implmentation file.**/
#Include “NativePublisher.h”
/** Code that calls the function (add)
published by the NativePublisher.DLL to
be imported. The underlying code also is
generated only for those published
methods as selected by the
Integrator/developer during the
deployment process. **/
extern “C”_declspec (dllimport) int add (int,int);
/** Code that Loads the DLL or OBJ file
which defines the function to be
imported**/
HINSTANCE hMod =::
LoadLibrary(“NativePublisher.dll”);
/** Here instead of a LoadLibrary(“x.dll) it
would be LoadLibrary(“x.obj”) for a OBJ
File.**/
// Jni Implementation of the method
defined in the .DLL or .OBJ file**/
typedef int (*PExe0)(int,int);
JNIEXPORT jint JNICALL
Java_NativePublisher_NativeMethod0(JNIEnv
*env,jobject obj,jint argument0,jint argument1) {

PExe0 pexe0 =NULL;

The CPP file of the above example loads the DLL (it may even be a OBJ file if the same is selected to be scaled to Java) when called upon by the Server. The Server calls upon the RMI Implementation of this File. The RMI Implementation in turn calls upon this file which when called upon loads the required DLL file and instantiates it to get the method execution to take place successfully. Normally this entire process is done manually, by coding the CPP File then subsequently generating the implementation file for this CPP file in Java and then making calls on the same through the Java implementation file. The present invention automates this process. The code generated contains only the published methods and does not contain all the methods of the NativePublisher.dll. Upon compilation, a JNativePublisher.dll is generated, which is called by the NativePublisher.Java program.

3. The Native Translator then generates the Java Implementation program 303 NativePublisher.Java in this case), which calls upon this file. The Java Implementation program invokes the JNI (Java Native Interface) Mechanism to facilitate the call on the Native Program (JNativePublisher.dll) 303. An example of a Java Implementation program is given in Table J.

TABLE J

//Implementation file:NativePublisher.java
* This is Implementation file for the
Methods defined in the .DLL or .OBJ
Object. The native function will call the
methods defined in the .DLL or the .OBJ
file of the generated Cpp file. This is the
Java code that inturn calls upon the C++
code.**/
class NativePublisher {
// Prototype of the method NativeMethod
public native int NativeMethod0(int argument0,int argument1);

static {

System.loadLibrary(“JNativePublisher.dll”);

/** Loads the Native .DLL or .OBJ file of
the Native Publisher **/

}

// Constructor of the Implementation class
public NativePublisher( ) {

super( );

}
/** Calls the native method which in turn
loads the .DLL or the .OBJ file and returns
the result**/
public int add(int argument0,int argument1) {

int

$var0=NativeMethod0(argument0,argument1);

return $var0;

}
}

4. The Native Translator then compiles the Java Native Interface Implementation 304 using standard Java compilers to produce a CPP Header file for the CPP implementation 304. The underlying is the code of the Header File (NativePublisher.h) generated by the Java Compiler when the JAVAH compilation is done on the Java implementation file (NativePublisher.Java). Table K is an example of a CPP Header file.

TABLE K

| | |
|---|---|
| // HeaderFile: NativePublisher.h | |
| // This header file is generated by JAVAH | // |
| compilation of the NativePublisher.Java | // |
| Implementation file. | |
| // DO NOT EDIT THIS FILE - it is machine | // |
| generated | |
| #Include <jni.h> | |
| // Header definition for class NativePublisher | |
| #ifndef_Included_NativePublisher | |
| #define_Included_NativePublisher | |
| #ifdef_cplusplus | |
| extern “C” { | |
| #endif | |
| /* | |
| * Class: NativePublisher | |
| * Method: NativeMethod0 | |
| * Signature: (II)I | |
| */ | |
| JNIEXPORT jint JNICALL | |
| Java_NativePublisher_NativeMethod0 | |

(JNIEnv *,jobject,jint,jint);

#ifdef_cplusplus
}
#endif
#endif

5. The Native Translator then submits the files generated, namely, NativePublisher.cpp, NativePublisher.h and NativePublisher.Java, for compilation 305. The first two files may be compiled using a standard C++ compiler (in one example, Microsoft Visual C++ compiler) and the NativePublisher.Java file may be compiled using a standard Java compiler (in one example, Sun Java compiler).

6. The Object Access Specifier creates an interface (NativePublisherInterface in this case), which contains the published methods, by extending the class file (NativePublisher.class) 306.

7. The Object Distributor then generates the implementation file (nativePublisherImpl) for the interface generated 307. The implementation file thus generated may contain code for distributing the object 308, code for registering the object with the RMI registry, and code for calling the published methods.

8. The Object Integrator then generates code to integrate the object with the distributed environment 309.

9. The Object Distributor and Integrator then compiles the generated code and subsequently copies the output files to the destination specified by the user 310, 601.

10. The Object Distributor and Integrator then places the reference files of the publishing object with the server (in this case NativePublisher reference files) 602. Thus making the Publishing object or program distributed and integrating it with the server, middleware or any application implementing this invention.

When the Subscriber calls for the subscribed method of the publisher, the server, middleware, or the application implementing this invention, through Remote Method Invocation (RMI) and the publishers reference invokes the published methods 605.

What is claimed is:

1. A system for distributing a non-distributed computer code object having at least one public method in a distributed environment having middleware, the system comprising:
a) a server configured to extract at least one method corresponding to the object in the distributed computing environment;
b) the server further configured to generate distribution code to enable the distribution of the object; and,
c) the server further configured to generate integration code specific to the middleware onto which the object is integrated.

2. The system of claim 1, wherein the object is deployed as a publisher.

3. The system of claim 1, wherein the object is deployed as a subscriber.

4. The system of claim 3, wherein the server is configured to generate subscription specific code for the subscriber object, including method invocation code for subscribed methods of the publishers to which the subscriber object is subscribed, and the implementation of the Publisher's Java Interface.

5. The system of claim 1, wherein the server is configured to publish at least one method.

6. The system of claim 1, wherein the server is configured to allow the subscription of at least one method.

7. The system of claim 1, wherein the extracted method is made public by the object.

8. The system of claim 1, wherein the object is a Java program having a plurality of public methods, and the server is further configured to
a) extract the plurality of public methods of the object;
b) allow for the selection of at least one of the extracted public method; and
c) publish the selected extracted public method.

9. The system of claim 1, wherein the server is further configured to:
a) extract a plurality of public methods of at least one publisher object from a repository of middleware;
b) allow for the selection of at least one of the extracted public method; and
c) subscribe at least one subscribing object to the selected extracted public method.

10. The system of claim 9, wherein the configuration of the server to extract a plurality of public methods further comprises the server configured to:
a) locate and read the repository;
b) extract a list of publishers and published methods corresponding to the list of publishers from the repository;
c) prepare a storage object that stores the extracted contents of the repository; and
d) display the extracted contents of the repository from the storage object for selection by a user.

11. The system of claim 9, wherein the configuration of the server to allow for the selection of at least one of the extracted public method further comprises the server configured to:
a) display a plurality of public methods to a user;
b) allow the user to select at least one method from the displayed plurality of public methods through a user interface; and
c) prepare a storage object that stores the selected method.

12. The system of claim 9, wherein the repository is located remotely from the server.

13. The system of claim 1, wherein the object is in native binary code and the server is further configured to translate native binary code into Java bytecode.

14. The system of claim 13, wherein the configuration of the server to translate native binary code into Java bytecode further includes the server configured to generate a computer program containing an implementation of the object's published methods in C++ language and to generate a Java Native Interface implementation program in Java, containing the implementation of the object's published methods in C++ language.

15. The system of claim 1, wherein the object is a publisher object having published methods, and the configuration of the server to generate distribution code further comprises the server configured to:
a) generate a Java Interface containing the published methods; and
b) generate a Java implementation program, implementing the generated Java Interface, and containing a Remote Method Invocation Mechanism.

16. A method for dynamically distributing and integrating a non-distributed object in a distributed environment comprising the steps of:
a) selecting at least one method of the non-distributed object;
b) generating distribution code to enable the distribution of the object; and,
c) integrating the object in the distributed environment.

17. The method of claim 16, where the object is deployed as publisher object having public methods available for use by subscriber objects.

18. The method of claim 16, where the object is deployed as subscriber object.

19. The method of claim 16, wherein the object comprises a plurality of objects comprising subscriber objects and publisher objects.

20. The method of claim 19, further comprising:
a) extracting at least one method for each object;
b) storing methods selected for publishing and subscribing;
c) for each non-Java object, generating translation code to translate the non Java object into a Java object;
d) generating distribution code for each publisher object;
e) generating subscription specific code for each subscribing object, wherein the subscription specific code contains subscribed methods of at least one publisher object;
f) generating integration specific code to integrate each object with middleware; and
g) generating archive files for distributing a final output after compilation.

21. The method of claim 20, wherein at least one object is a Java program having a plurality of public methods, and the step of extracting at least one method for the object further comprises:
a) extracting a plurality of public methods of the object;
b) allowing for the selection of at least one of the extracted public method; and
c) publishing the selected extracted public method.

22. The method of claim 20, wherein at least one object is a subscriber object, and the step of extracting at least one method for the object further comprises:
a) extracting a plurality of public methods of at least one publisher object from a repository of middleware;
b) allowing for the selection of at least one of the extracted public method; and
c) subscribing the subscriber object to the selected extracted public method.

23. The method of claim 22, wherein the step of extracting a plurality of public methods of at least one publisher object from a repository of middleware further comprises
a) locating and reading the repository;
b) extracting a list of publishers and published methods corresponding to the list of publishers from the repository;
c) preparing a storage object that stores the extracted contents of the repository; and
d) displaying the extracted contents of the repository from the storage object for selection by a user.

24. The method of claim 20, wherein the step of extracting at least one method for each object further comprises the steps of:
a) displaying a plurality of public methods to a user;
b) allowing the user to select at least one method from the displayed plurality of public methods through a user interface; and
c) preparing a storage object that stores the selected method.

25. The method of claim 20, wherein at least one object comprises a native language publisher object, and the step for generating the distribution code further comprises translating native code into Java bytecode.

26. The method of claim 25, wherein the native language publisher object has published methods and the step of translating native code into Java bytecode comprises
a) generating a computer program implementing the published methods of the native language publisher object in C++ language; and
b) generating of a Java Native Interface implementation program in Java, containing the published methods of the native language publisher object in C++ language.

27. The method in claim 26, where the implementation of the generated Java Native Interface comprises the steps of generating a Java implementation program containing the Remote Method Invocation.

28. The method in claim 27 further comprising the steps of
a) generating implementation code implementing the Java Native Interface;
b) generating implementation code of the published methods; and
c) generating Remote Method Invocation code.

29. The method of claim 20, wherein the step of integrating the object further comprises the step of generating integration code specific to the distributed environment.

30. The method in claim 20 wherein the step of storing methods selected for publishing and subscribing further comprises storing methods selected for publishing and subscribing in a local repository.

31. The method in claim 20 wherein the step of storing methods selected for publishing and subscribing further comprises storing methods selected for publishing and subscribing in a remote repository.
